(19) United States
(12) Patent Application Publication
(10) Pub. No.: US 2026/0165302 A1
(43) Pub. Date: Jun. 18, 2026

(54) Methods and Systems for Identifying a Mobility Condition

(71) Applicant: IDEXX Laboratories, Inc., Westbrook, ME (US)

(72) Inventor: Timothy Gardner, Portland, ME (US)

(73) Assignee: IDEXX Laboratories, Inc., Westbrook, ME (US)

(21) Appl. No.: 19/300,382

(22) Filed: Aug. 14, 2025

Related U.S. Application Data
(60) Provisional application No. 63/734,319, filed on Dec. 16, 2024.

(51) Int. Cl. A01K 29/00

(52) U.S. Cl. CPC A01K 29/007

(57) ABSTRACT

A method for identifying a condition includes: (a) receiving biometric data associated with movement of a subject; (b) determining whether the biometric data comprises one or more values exceeding a configurable threshold indicative of an abnormal event; (c) associating the received biometric data with a profile of the subject, the profile comprising anatomical data of the subject; (d) applying a machine learning algorithm to the received biometric data and the profile; (e) determining, via the machine learning algorithm and based at least in part on the received biometric data and the anatomical data of the subject, whether the biometric data exceeds a diagnostic threshold; and (f) in response to determining that the biometric data exceeds the diagnostic threshold, sending a signal to a computing device.

### CROSS-REFERENCE TO RELATED APPLICATIONS

This application claims the benefit of co-pending U.S. Provisional Patent Application Serial No. 63/734,319, filed December 16, 2024, which is hereby incorporated by reference in its entirety.

### FIELD OF THE DISCLOSURE

The present disclosure involves models and systems for veterinary applications. More particularly, the present disclosure relates to machine learning models for analyzing and identifying mobility disorders in animal subjects.

### BACKGROUND

Mobility disorders, such as osteoarthritis and hip dysplasia, are common among animals, such as dogs and cats. Osteoarthritis is a degenerative joint disease that causes pain, stiffness, and swelling the joints. Symptoms of osteoarthritis can include lameness, reduced activity, stiffness, limping, changes in behavior, and reduced activity. Hip dysplasia is a condition that causes abnormal hip joint development. It can affect one or more hip joints and can range from a mild abnormality to a complete dislocation. Hip dysplasia can lead to bone degeneration, pain, and reduced mobility.

Typically, diagnoses of these disorders in animals involves a screening during a clinical veterinary visit. More particularly, veterinarians generally rely on abnormalities in a physical exam to recognize the possibility or increased likelihood of mobility disorders. In some instances, additional diagnostic, laboratory testing, and/or imaging (e.g., X-Rays, Computed Tomography (CT) scan, and/or magnetic resonance imaging (MRI)), may be required to definitively diagnose a disorder.

Early diagnosis and treatment of these mobility disorders can help manage the pain and progression of the disorder. However, the lack of clinical signs and the absence of adequate screening can make it difficult to diagnose mobility disorders at an early stage, where interventions and therapies are most effective.

Continuous monitoring using biometric measurement devices (e.g., wearable devices, cameras, etc.) can be helpful to recognize signs at the early stages of these disorders. However, these devices generate large amounts of data that are not readily understood. Particularly, because widespread utilization of biometric measurement devices is relatively nascent, relevant data (i.e., data associated with diagnostically relevant events) may not be discernable from noise (i.e., data associated with normal events or abnormal but benign events). Accordingly, caretakers may be inundated with data, reducing the perceived value of the biometric data and use of biometric devices.

### SUMMARY

In an example, a computer implemented method for identifying a condition, the method including receiving biometric data associated with movement of a subject. The method also includes determining whether the biometric data comprises one or more values exceeding a configurable threshold indicative of an abnormal event. The method additionally includes associating the received biometric data with a profile of the subject, the profile comprising anatomical data of the subject. The method further includes applying a machine learning algorithm to the received biometric data and the profile. The method also includes determining, via the machine learning algorithm and based at least in part on the received biometric data and the anatomical data of the subject, whether the biometric data exceeds a diagnostic threshold. The method additionally includes in response to determining that the biometric data exceeds the diagnostic threshold, sending a signal to a computing device.

In another example, a non-transitory computer-readable medium, having stored thereon program instructions that, upon execution by a processor, cause performance of a set of operations including receiving biometric data associated with movement of a subject. The set of operations also includes determining whether the biometric data comprises one or more values exceeding a configurable threshold indicative of an abnormal event. The set of operations additionally includes associating the received biometric data with a profile of the subject, the profile comprising anatomical data of the subject. The set of operations further includes applying a machine learning algorithm to the received biometric data and the profile. The set of operations also includes determining, via the machine learning algorithm and based at least in part on the received biometric data and the anatomical data of the subject, whether the biometric data exceeds a diagnostic threshold. The set of operations additionally includes in response to determining that the biometric data exceeds the diagnostic threshold, sending a signal to a computing device.

In another example, a computing system includes a processor and a non-transitory computer-readable medium, having stored thereon program instructions that, upon execution by the processor, cause performance of a set of operations. The set of operations also includes determining whether the biometric data comprises one or more values exceeding a configurable threshold indicative of an abnormal event. The set of operations additionally includes associating the received biometric data with a profile of the subject, the profile comprising anatomical data of the subject. The set of operations further includes applying a machine learning algorithm to the received biometric data and the profile. The set of operations also includes determining, via the machine learning algorithm and based at least in part on the received biometric data and the anatomical data of the subject, whether the biometric data exceeds a diagnostic threshold. The set of operations additionally includes in response to determining that the biometric data exceeds the diagnostic threshold, sending a signal to a computing device.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2 illustrates a measurement device configured for use with an assessment platform and a mobile computing device, according to an example embodiment.

FIG. 3 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to methods and systems for identifying a potential abnormal event related to the movement of a subject, such as a dog or a cat, and determining whether the abnormal event exceeds a diagnostic threshold, determined based on profile information related to the subject, to alert a pet owner or veterinarian, for example.

To do so, systems and methods of the present disclosure utilize a computing device to first analyze biometric data to determine when an abnormal event has occurred. More particularly, the computing system can determine whether a metric or measurement in the subject’s biometric data exceeds a configurable threshold. The configurable threshold is based on the type of biometric data received and how an abnormality is identified based on the type of biometric data. For instance, in example implementations, the biometric data may relate to the weight distribution between legs when the subject is walking or running. The configurable threshold can be a minimum difference in the weight distribution between legs to indicate a potential abnormality.

Once it is determined that the biometric data exceeds the configurable threshold indicating an abnormal event, the computing device can utilize a machine learning algorithm to determine a diagnostic threshold based on information about the subject (e.g., breed, sex, weight, age, medical history, etc.). In this manner, the diagnostic threshold may be different than the configurable threshold, as the diagnostic threshold takes into account information about the subject.

The computing device can then determine whether a metric or measurement in the subject’s biometric data exceeds the diagnostic threshold. If so, the computing device may send an alert to a device (e.g., a phone, a computer, etc.) indicating the occurrence of the abnormal event. In this manner, the alerts and information provided to the caretaker of the subject are limited. The provided information that is presented to the caretaker and veterinary staff is also and curated to the subject.

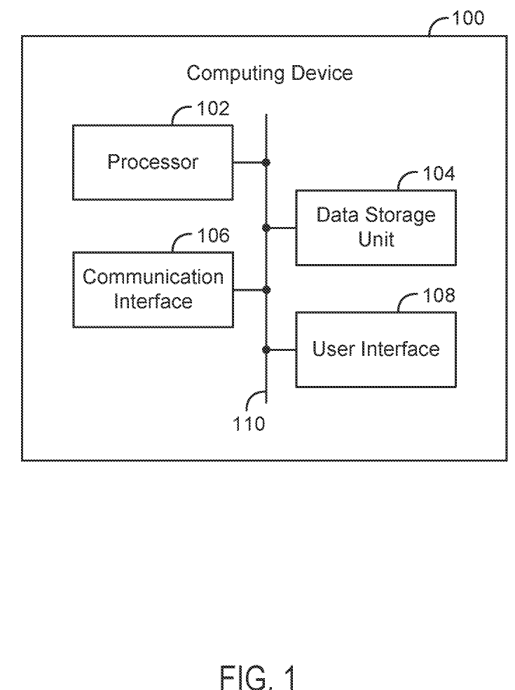

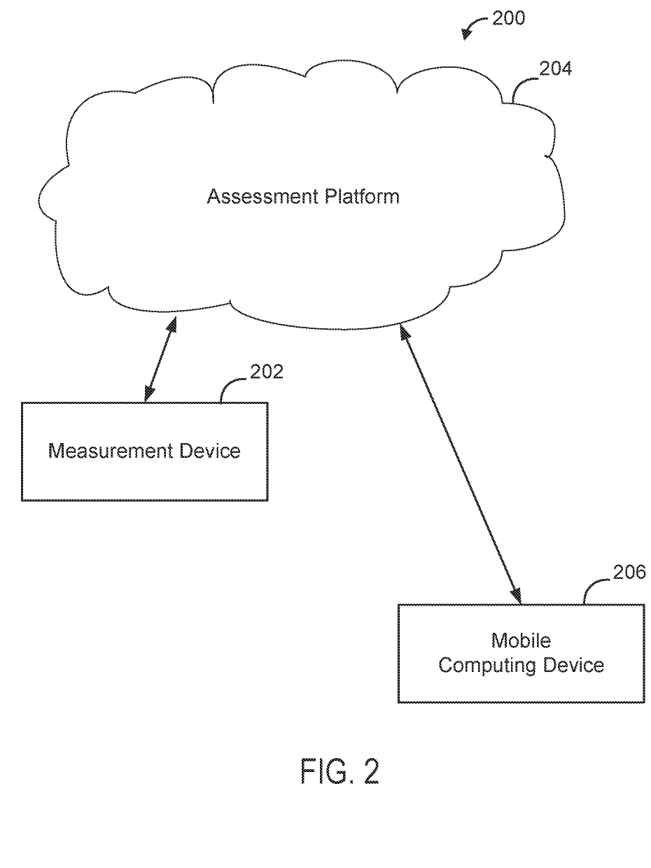

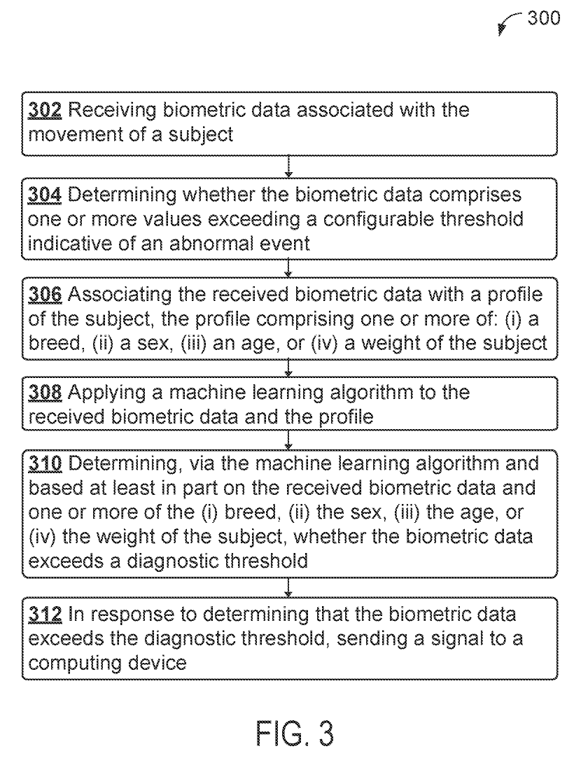

Referring now to the figures, FIG. 1 is a simplified block diagram of an example computing device 100 of a system (e.g., that can be utilized with devices and methods illustrated in FIGS. 2-3, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor and/or a central processing unit (CPU)) and/or a special-purpose processor (e.g., a digital signal processor (DSP) and/or a graphics processing unit (GPU)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIG. 2, a computing system 200 configured for use with a measurement device 202 and a mobile computing device 206, according to an example embodiment. The measurement device 202 and the mobile computing device 206 are both communicably coupled to an assessment platform 204. The measurement device 202 includes a computing device, such as computing device 100. The mobile computing device 206 also includes a computing device, such as computing device 100. The assessment platform 204 also includes a computing device, such as computing device 100. It should also be readily understood that computing device 100, measurement device 202, assessment platform 204, and mobile computing device 206, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

An example method for identifying a condition can first involve receiving biometric data associated with the movement of a subject. The computing system 200 can then determine whether the biometric data comprises one or more values exceeding a configurable threshold indicative of an abnormal event. The computing system 200 can then associate the received biometric data with a profile of the subject, the profile comprising anatomical data of the subject. The computing system 200 can then apply a machine learning algorithm to the received biometric data and the profile. The computing system 200 can then determine, via the machine learning algorithm and based at least in part on the received biometric data and the anatomical data of the subject, whether one or more values exceeds the diagnostic threshold. In response to determining that the biometric data exceeds the diagnostic threshold, he computing system 200 can then send a signal to a computing device.

As noted above, to identify, the computing system 200 can first receiving biometric data associated with the movement of a subject. In examples implementations, the biometric data is received by the assessment platform 204.

In example implementations, biometric data can include one or more of the following: (i) weight distribution; (ii) balance; (iii) movement patterns; (iv) step distance; (v) step height; (vi) foot contact time; (vii) similarity between legs; (viii) pace; (ix) step cadence; (x) step irregularities; (xi) delay of step on one side; (xii) foot strike; (xiii) heart rate; (xiv) location; and/or (xv) muscle and/or tissue stiffness. Additionally or alternatively, biometric data can include a captured image or video of the subject. For instance, the biometric data can include a video of the subject walking and/or running. In examples, biometric data can also include one or more identifiers of a subject. For instance, the biometric data can include the subject’s name or another identifier, such as a numeric, alpha, or alphanumeric code associated with the subject. Many examples of biometric data are possible.

In examples, a measurement device 202 collects biometric data. The measurement device 202 is communicably coupled to the assessment platform 204, for example, according to one or more protocols (e.g., cellular, WI FI, HD-SDI, ethernet cable, etc.). Accordingly, the measurement device 202 is configured to transmit collected biometric data to the assessment platform 204. In some examples, the measurement device 202 and the mobile computing device 206 may be the same device (e.g., a smartphone). In some examples, the measurement device 202 is communicably coupled to the mobile computing device 206, for example, according to one or more protocols (e.g., cellular, WI FI, HD-SDI, ethernet cable, etc.). The mobile computing device 206 may be communicably coupled to the assessment platform 204, for example, according to one or more protocols (e.g., cellular, WI FI, HD-SDI, ethernet cable, etc.). In these examples, the measurement device 202 may transmit collected biometric data to the mobile computing device 206. The mobile computing device 206 may then transmit the biometric data to the assessment platform 204.

An example measurement device 202 can collect data utilizing a variety of different techniques and technologies. In examples, to capture the biometric data, the measure device 202 can include an accelerometer and/or a gyroscope to collect movement based data (e.g., weight distribution, balance, movement patterns, step distance, step height, similarity between legs, pace; step cadence, step irregularities, delay of step on one side of the subject, etc.). Additionally or alternatively, the measurement device 202 can include an electrical sensor to measure the heart rate of the subject. Additionally or alternatively, the measurement device 202 can include global positioning system (GPS), radio frequency identification (RFID), or similar, to collect location based data of a subject (e.g., location, pace, movement patterns, etc.). Additionally or alternatively, the measurement device 202 can utilize techniques related to electromyography (EMG), mechano-myography, ultrasound elastography, or similar, to collect data related to muscle and/or tissue stiffness.

In example implementations, the measurement device 202 includes a wearable device, worn by, or otherwise attached to, a subject over a configurable period of time. For instance, example wearable devices can include one or more of the following: (i) one or more boots; (ii) one or more ankle braces; (iii) a harness; (iv) a collar; (v) a tag; (vi) a helmet; and/or (vii) an RFID tag. In example implementations, one or more of these example devices may be attached to a limb (e.g., a leg or ankle) of a subject. Additionally or alternatively, one or more of these example devices may be attached to a neck of a subject (e.g., a collar). Other examples of wearable devices are possible.

Additionally or alternatively, the measurement device 202 can include a treadmill to collect biometric data. For example, a treadmill can include sensors to collect certain biometric data such as weight distribution, balance, movement patterns, step distance, step height, foot contact time, similarity between legs, pace, step cadence, step irregularities, delay of step on one side, and/or foot strike. Additionally or alternatively, force plates may be utilized to conduct a kinetic gait analysis. A treadmill can be used as a measurement device 202 alone or in combination with other measurement devices (e.g., heart rate monitor and/or one or more boots).

Additionally or alternatively, in some example implementations, the measurement device 202 can include an image capture device and/or sensor, such as a camera on a smartphone. In these examples, the biometric data can include one or more pictures or videos of the subject. For instance, in an example implementation, the biometric data can include a video of the subject walking or running. Other examples are possible.

In some examples, the measurement device 202 can include a sensor to measure muscle and/or tissue stiffness. For instance, an example measurement device can include a probe that oscillates against a muscle at a certain frequency. The measure device 202 can measure physical displacement of the muscle and/or a response frequency, which can indicate tone, stiffness, and elasticity in the muscle tissue, as well as other biomechanical and elastic properties of the muscle tissue.

In example implementations, the measurement device 202 collects biometric data over a configurable period of time. In some examples, the period of time can be relatively short, such as a few second or minutes. For instance, an example measurement device 202, such as a camera on a smart phone, can record a video of a subject walking or running for a few seconds. In other examples, the measurement device 202 can collect data over a period of days, weeks, or months. For instance, a subject may wear a wearable measurement device 202 over a number days. In some examples, the subject may wear a wearable measurement device 202 for a period of time (e.g., one hour) each day over a number of weeks. In another example, biometric data measured at different times (e.g., two months apart from each other) can be measured and compared. Many examples are possible.

Once the measurement device 202 collects and transmits biometric data to the assessment platform 204, the assessment platform 204 can determine whether the biometric data includes one or more values exceeding a configurable threshold indicative of an abnormal event. The configurable threshold is based on the type of biometric data received and how an abnormality is identified based on the type of biometric data. For instance, in example implementations, the biometric data received may relate to the weight distribution between legs when the subject is walking or running. The configurable threshold can be a minimum difference in the weight distribution between legs to indicate a potential abnormality. In some examples, the biometric data can indicate a slight abnormality in the weight distribution of the subject, which may not exceed the configurable threshold. In other examples, the biometric data can indicate a more severe or prominent abnormality in the weight distribution of the subject, which may exceed the configurable threshold.

Additionally or alternatively, in example implementations the configurable threshold can relate to the amount of time during which the abnormality is detected. For instance, if the biometric data indicates that an abnormality such as a limp is detected for a few seconds or minutes, this may not exceed a configurable threshold period of time. In other examples, if the biometric data indicates that an abnormality such as a limp is detected for a number of hours or days, this may exceed the configurable threshold period of time. In some example implementations, the configurable threshold can include a combination of factors, such as a threshold severity and a threshold period of time. Many example implementations are possible.

Once the assessment platform 204 has determined that the biometric data includes one or more values exceeding the configurable threshold, the assessment platform 204 can associate the received biometric data with a profile of the subject. In example implementations, the assessment platform 204 can include a database storing a number of profiles associated with different subjects. Profiles can include anatomical data about the subject. For instance, anatomical data can include, but is not limited to, one or more of the following: (i) breed; (ii) sex; (iii) weight; (iv) age; (v) location; and/or (vi) medical record. In some examples, a subject’s medical record can include, but is not limited to, subject demographic information, vital signs at each clinical visit, diagnoses, medications, treatment plans, progress notes, subject problems, vaccine history, test results, and imaging data, such as radiographs. The demographic data may include species, breed, weight, age, gender, and geographic location, for example. In some examples, the profile of the subject may also include information on test results (for example, complete blood count (CBC), blood chemistry, pathology, urinalysis, serology, and PCR (polymerase chain reaction) panels/assays), vector of exposure, and diagnoses.

In some examples, the profile of the subject can include or indicate changes over time. For example, the profile of the subject can include an increase or decrease in the subject’s weight over time. In some example implementations, the assessment platform 204 may save the received biometric data to the database to update the subject’s profile and/or the machine learning algorithm.

In some example implementations, associating the received biometric data with a profile of the subject can include mapping a subject identifier included in the biometric data to a subject identifier in the profile (e.g., subject’s name and/or numeric, alpha, or alphanumeric code specific to the subject). Other techniques of associating the biometric data to profile of a subject are possible.

In some examples, if a profile does not exist, or has not been created for a subject, the assessment platform 204 can create and/or prompt a user (e.g., a pet owner) to create a profile of the subject. For instance, a user may receive a message (e.g., text message, e-mail, notification, etc.) prompting a user to create a profile for a subject. In some examples, this message may be sent to a mobile computing device 206 associated with the subject and/or user.

Once the received biometric data is associated with the profile of the subject, the assessment platform 204 can apply a machine learning algorithm to the received biometric data and the profile. The assessment platform 204 can then determine via the machine learning algorithm and based at least in part on the received biometric data and information obtained from the profile of the subject, whether the biometric data exceeds a diagnostic threshold. In example implementations, the diagnostic threshold is different than the configurable threshold. For instance, in examples, the diagnostic threshold is determined based on information related to the subject.

As noted above, determining whether the received biometric data exceeds a diagnostic threshold can be based both on the received biometric data and anatomical data (e.g., breed, sex, age, or weight of the subject). For instance, certain breeds of dogs have an increased are at a higher risk for mobility disorders, thus the diagnostic threshold may be adjusted specific to the breed. For example, German Shepherds, Golden Retrievers, Labrador Retrievers, Saint Bernards, Great Danes, and Newfoundlands are more susceptible to hip dysplasia than other breeds. Accordingly, the diagnostic threshold for the subject of one of these breeds may be adjusted to detect a less severe abnormality than that of other breeds, as the subject is already at a higher risk of a mobility condition.

In another example, the profile of the subject may indicate that the subject has a history of an abnormal weight distribution, for example, in the subject’s medical records. In this example, the diagnostic threshold may be adjusted to account for this historical abnormality. Namely, the diagnostic threshold can help to determine whether the abnormality has worsened over time. If the biometric data indicates the abnormality is more severe than the historical data, the machine learning algorithm may determine that the biometric data exceeds the diagnostic threshold.

In another example, the profile of the subject may indicate that the subject’s weight has increased over time, which may indicate an increased likelihood of a mobility disorder. In this example, the diagnostic threshold may be adjusted to account for this change. Namely, the diagnostic threshold for the subject may be adjusted to detect a more mild abnormality, as the subject is already at a higher risk of a mobility condition.

In another example, the machine learning algorithm may detect a slight limp in the subject’s biometric data, however information in the subject’s profile does not indicate any increased risk factors of mobility disorders, for examples. In this case, the machine learning algorithm may determine that the biometric data does not exceed the diagnostic threshold. Many examples are possible.

The machine learning model may be trained using training data that shares a characteristic with a subject to be analyzed by the measurement device 202. Training the machine learning model may include inputting one or more training data samples into the machine learning model, predicting, by the machine learning model, an outcome of a determined condition of the one or more training data samples, comparing the at least one outcome to the characteristic of the one or more training samples, and adjusting, based on the comparison, the machine learning model. For example, if a user is attempting to determine whether an abnormal event is a benign occurrence or indicative of a more problematic issue, such as a mobility disorder, based on whether biometric data indicates that a diagnostic threshold has been exceeded, the machine learning model may be trained by inputting training data of subjects with known mobility disorders, predicting, by the machine learning model, a likelihood of the mobility disorder, comparing the predicted likelihood to the known likelihood, and adjusting, based on the comparison, the diagnostic threshold of the machine learning model.

In some examples, the training data may include labeled training data (supervised learning), partially labeled training data (semi-supervised learning), or unlabeled training data (unsupervised learning). In some examples, training may include reinforcement learning.

The machine learning model may include an artificial neural network, a support vector machine, a regression tree, an ensemble of regression trees, or some other machine learning model architecture or combination of architectures.

The training data may include data obtained from tests performed either at laboratories or using instruments at the POC terminal, and clinical history data derived from integrated veterinary clinic practice information management software (PIMS). The training data may additionally or alternatively include images or videos of subjects walking or running. In some aspects of the disclosure, the data samples are collected over a period of time and stored in the one or more databases.

In some examples, the machine learning model of the assessment platform 204 may be adjusted based on training such that the outcome of the determined diagnostic threshold was an appropriate threshold to, for example, indicate an increased likelihood of a mobility order, and matches the training data, the machine learning model is reinforced and if the outcome of a determined diagnostic threshold does not match the training data of the training data, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

In some examples, the machine learning model of the assessment platform 204 may be adjusted based on changes in the profile of the subject. In some examples, the profile of the subject can include or indicate changes over time. For example, the profile of the subject can include an increase or decrease in the subject’s weight over time. The assessment platform 204 may save the subject’s data to the database to update the subject’s profile and/or the machine learning algorithm.

In some examples, identifying an abnormal event based on the determined diagnostic threshold can also involve receiving test results data associated with the subject. In examples, the test result data includes data associated with a biological sample of the subject. For instance, in examples, the biological sample of the subject can include, but is not limited to, one or more of the following: blood, urine, saliva, fecal matter, secretion, excretion, Fine Needle Aspirate (FNA), lavage fluids, body cavity fluids, semen, bacteria, ear wax, skin cells, fecal matter, and biopsied samples. Test may additionally include one or more of the following: blood coagulation test, polymerase chain reaction (PCR) test, and/or immunoassay, among other possibilities.

In example implementations, the test result data may include a marker associated with the mobility disorder. For instance, certain levels of glucose, lactate, and pH in synovial fluid (SF) can be used to detect or indicate an increased likelihood of osteoarthritis in dogs. Additionally or alternatively, some pro-inflammatory and degenerative markers, such as, tumor necrosis factor alpha (TNF-alpha), interleukin-1beta (IL-1beta), tenascin-c (TN-C), and matrix metalloproteinase-2 (MMP-2), may be an indicator or osteoarthritis in a subject. Some markers, such as urinary CTX-I and II, serum MMP-9, and serum PIICP, can be used to identify hip dysplasia in subject. In some examples, if a test result reaches a threshold level of a marker, the machine learning algorithm may determine that the subject has a high likelihood of a mobility disorder.

In some example implementations, the assessment platform 204 may change and/or update the machine learning algorithm based at least in part on whether the test result data includes the marker. For instance, in some examples, modifying the machine learning model can includes increasing or decreasing a weight of a factor, such as the existence and/or level of a marker, within the neural network of the machine learning model. In other examples, modifying the machine learning model includes adding or subtracting rules, such as factoring in the existence and/or level of a marker, during the training of the machine learning model.

Once the assessment platform 204 has determined that the biometric data has one or more values that exceed a diagnostic threshold, the assessment platform 204 may send a signal to a computing device. In some examples, the assessment platform 204 can transmit instructions that cause a computing device (e.g., the computing device 100) to display one or more graphical indications that the subject’s biometric data exceeded a diagnostic threshold. This may, for example, signal to a pet owner and/or veterinarian that a detected abnormality may need to be assessed further. In examples, the assessment platform 204 may transmit instructions to a user device, such as a smartphone associated with the subject, to display one or more graphical indications of a determined likelihood that the subject.

In some example implementations, the assessment platform 204 is used to provide alerts to clinicians (e.g., veterinarians) when a subject has an increased likelihood of a mobility disorder. For instance, the assessment platform 204 may send a signal to a veterinary computing device separate from the user computing device (e.g., mobile computing device 206). This may indicate to the veterinarian that further targeted screening may be performed, in response to the alert, to validate the presence/absence of an abnormality and/or a mobility disorder. This approach provides significant advantages for recognizing and treating mobility disorders by helping pet owners and veterinarians identify abnormalities specific to the subject. Further, this approach can help reduce the number of missed diagnoses of early-stage mobility disorders prior to a crisis. Additional potential benefits of this approach include training veterinarians to recognize subjects with abnormalities, which in some cases may lead to mobility disorders, prior to the worsening symptoms and highlighting the potential significance of nonspecific recurring clinical signs in recognizing the risk for mobility disorders.

### EXAMPLE METHODS AND ASPECTS

Now referring to FIG. 3, an example computer implemented method for identifying a condition. Method 300 shown in FIG. 3 presents an example computer implemented method for identifying a condition that could be used such as the computing device 100 and/or computing system 200 shown in FIGS. 1-2, for example. Further, devices or systems may be used or configured to perform logical functions presented in FIG. 3. In other examples, components of the devices and/or systems may be arranged to be adapted to, capable of, or suited for performing the functions, such as when operated in a specific manner. Method 300 may include one or more operations, functions, or actions as illustrated by one or more of blocks 302-308. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, method 300 involves receiving biometric data associated with movement of a subject.

At block 304, method 300 involves determining whether the biometric data comprises one or more values exceeding a configurable threshold indicative of an abnormal event.

At block 306, method 300 involves associating the received biometric data with a profile of the subject, the profile comprising anatomical data of the subject. In some examples, the profile of the subject further comprises a medical record of the subject. In these examples, the medical record comprises test result data associated with a biological sample of the subject.

At block 308, method 300 involves applying a machine learning algorithm to the received biometric data and the profile.

At block 310, method 300 involves determining, via the machine learning algorithm and based at least in part on the received biometric data and one or more of the breed, the sex, the age, or the weight of the subject, whether the biometric data exceeds a diagnostic threshold. In some examples, the diagnostic threshold is different from the configurable threshold. Additionally or alternatively, in some examples the diagnostic threshold is determined based at least in part on the profile of the subject.

At block 312, method 300 involves in response to determining that the biometric data exceeds the diagnostic threshold, sending a signal to a computing device.

In some example implementations, the computing device is a user computing device. In these examples, method 300 may further involve in response to determining that the biometric data exceeds the diagnostic threshold, sending a signal to a veterinary computing device separate from the user computing device.

In some example implementations, method 300 may further involve receiving a signal to change the configurable threshold.

In some example implementations, method 300 may further involve saving the received biometric data to a database. In these examples, method 300 may further involve updating the machine learning algorithm using the database.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A computer implemented method for identifying a condition, the method comprising:
receiving biometric data associated with movement of a subject;
determining whether the biometric data comprises one or more values exceeding a configurable threshold indicative of an abnormal event;
associating the received biometric data with a profile of the subject, the profile comprising anatomical data of the subject;
applying a machine learning algorithm to the received biometric data and the profile;
determining, via the machine learning algorithm and based at least in part on the received biometric data and the anatomical data of the subject, whether the biometric data exceeds a diagnostic threshold; and
in response to determining that the biometric data exceeds the diagnostic threshold, sending a signal to a computing device.

2. The computer implemented method of claim 1, wherein the diagnostic threshold is different from the configurable threshold.

3. The computer implemented method of claim 1, wherein the diagnostic threshold is determined based at least in part on the profile of the subject.

4. The computer implemented method of claim 1, wherein the computing device is a user computing device, and wherein the method further comprises:
in response to determining that the biometric data exceeds the diagnostic threshold, sending a signal to a veterinary computing device separate from the user computing device.

5. The computer implemented method of claim 1, further comprising:
receiving a signal to change the configurable threshold.

6. The computer implemented method of claim 1, wherein the profile of the subject further comprises a medical record of the subject.

7. The computer implemented method of claim 6, wherein the medical record comprises test result data associated with a biological sample of the subject.

8. The computer implemented method of claim 1, further comprising:
saving the received biometric data to a database; and
updating the machine learning algorithm using the database.

9. A non-transitory computer-readable medium, having stored thereon program instructions that, upon execution by a processor, cause performance of a set of operations comprising:
receiving biometric data associated with movement of a subject;
determining whether the biometric data comprises one or more values exceeding a configurable threshold indicative of an abnormal event;
associating the received biometric data with a profile of the subject, the profile comprising anatomical data of the subject;
applying a machine learning algorithm to the received biometric data and the profile;
determining, via the machine learning algorithm and based at least in part on the received biometric data and the anatomical data of the subject, whether the biometric data exceeds a diagnostic threshold; and
in response to determining that the biometric data exceeds the diagnostic threshold, sending a signal to a computing device.

10. The non-transitory computer-readable medium of claim 9, wherein the diagnostic threshold is different from the configurable threshold.

11. The non-transitory computer-readable medium of claim 9, wherein the computing device is a user computing device, and wherein the set of operations further comprises:
in response to determining that the biometric data exceeds the diagnostic threshold, sending a signal to a veterinary computing device separate from the user computing device.

12. The non-transitory computer-readable medium of claim 9, wherein the set of operations further comprises:
receiving a signal to change the configurable threshold.

13. The non-transitory computer-readable medium of claim 9, wherein the profile of the subject further comprises a medical record of the subject.

14. The non-transitory computer-readable medium of claim 13, wherein the medical record comprises test result data associated with a biological sample of the subject.

15. The non-transitory computer-readable medium of claim 9, wherein the set of operations further comprises:
saving the received biometric data to a database; and
updating the machine learning algorithm using the database.

16. A computing system comprising:
a processor; and
a non-transitory computer-readable medium, having stored thereon program instructions that, upon execution by the processor, cause performance of a set of operations comprising:
receiving biometric data associated with movement of a subject;
determining whether the biometric data comprises one or more values exceeding a configurable threshold indicative of an abnormal event;
associating the received biometric data with a profile of the subject, the profile comprising anatomical data of the subject;
applying a machine learning algorithm to the received biometric data and the profile;
determining, via the machine learning algorithm and based at least in part on the received biometric data and the anatomical data of the subject, whether the biometric data exceeds a diagnostic threshold; and
in response to determining that the biometric data exceeds the diagnostic threshold, sending a signal to a user computing device separate from the computing system.

17. The computing system of claim 16, wherein the diagnostic threshold is different from the configurable threshold.

18. The computing system of claim 16, wherein the set of operations further comprises:
in response to determining that the biometric data exceeds the diagnostic threshold, sending a signal to a veterinary computing device, separate from the user computing device.

19. The computing system of claim 16, wherein the set of operations further comprises:
receiving a signal to change the configurable threshold.

20. The computing system of claim 16, wherein the profile of the subject further comprises a medical record of the subject.

21. The computing system of claim 20, wherein the medical record comprises test result data associated with a biological sample of the subject.
